(19) United States
(12) Patent Application Publication
(10) Pub. No.: US 2018/0349557 A1
(43) Pub. Date: Dec. 6, 2018

(54) METHOD AND SYSTEM FOR MANAGING RESERVATIONS OF OPERATING ROOM (OR) BLOCKS

(71) Applicant: LeanTaas, Santa Clara, CA (US)

(72) Inventors: Zetong LI, Menlo Park, CA (US); Rajendra PRASAD, Santa Clara, CA (US); Sanjeev AGRAWAL, Los Gatos, CA (US)

(21) Appl. No.: 15/613,163

(22) Filed: Jun. 3, 2017

(51) Int. Cl. G06F 19/00; G06F 3/0482

(52) U.S. Cl. CPC G06F 19/327; G06F 3/0482; G06F 19/322

(57) ABSTRACT

A method and system for managing reservation of operating room (OR) blocks is provided. In one embodiment, a server system causes display of at least one user interface (UI) configured to facilitate reservation of blocks and release of previously reserved blocks from among a plurality of blocks associated with each OR from among one or more ORs related to a clinical facility. The plurality of blocks associated with each OR together configure a pool of blocks. The server system receives a user request for one of reserving at least one block and releasing a user reservation of the at least one block. The server system performs at least one action in response to the received request and updates the UI based on the at least one action. The updated UI is configured to indicate a current available inventory of blocks from among the pool of blocks.

### TECHNICAL FIELD

The present disclosure generally relates to managing resources in clinical facilities and more particularly to a method and system for managing reservations of operating room (OR) blocks associated with clinical facilities.

### BACKGROUND

Operating rooms are typically reserved in advance for performing medical procedures, such as surgeries, on patients. The various time slots for which an operating room (OR) may be reserved are referred to herein as OR blocks. As such, an OR block is a limited resource at all clinical facilities, like hospitals, for instance. Typically, for OR block scheduling, many clinical facilities allow surgeons or group of doctors to have ownership of certain ORs on certain days of week. There may be occasions from time to time where surgeons may not need an OR block or two due to lack of cases at certain times or the surgeons may be involved in other activities, such as a vacation, conference, and the like. In such scenarios, an OR Block may be released to a certain specific surgeon so they may utilize the OR time or it may be released to no specific surgeon so that it becomes open time.

Generally, it is observed that surgeons having reservations of OR blocks forget to release the blocks in time to let other people have enough time to schedule cases in those ORs. Furthermore, in many example scenarios, the one-time release is sometimes not logged correctly into electronic medical record (EMR) as such communication may happen through multiple channels; for example, a surgeon may call his assistant to ask an OR scheduler to release a block, or a surgeon may write an email to the OR scheduler, or the surgeon may even drop by the office and verbally indicate the block release to the OR scheduler.

Typically, such one-time released blocks are infrequently picked up by other surgeons, as it is difficult to find a surgeon who happens to need the time. More often than not surgeons prefer releasing time to their close colleagues; however they may not have that demand. To find potential surgeons for an empty block time, OR schedulers may engage in phone calls to identify potential need. In many scenarios, to hold time for potential demand, sometimes OR schedulers may use stop gap methods such as having “sticky notes” on their EMR schedule grids to hold certain blocks (for example, OR scheduler may put a phantom case on the grid to prevent others from putting cases in the same time). However, finding potential need manually is inefficient and many times not effective. Moreover, using phantom case to hold time leads to unused block time due to lack of accountability and miscommunication.

In view of the above, there is a need to manage reservations of operating blocks in an efficient manner such that surgeons and schedulers can easily release unwanted blocks, and request needed blocks from the true available inventory. There is also a need to drive higher block utilization by ensuring a high level of accountability for block owners to either fill the blocks efficiently with patient cases, or to release them early if they are not able to.

### SUMMARY

Various embodiments of the present disclosure provide methods, systems, electronic devices and computer program products for managing reservations of operating room (OR) blocks associated with several ORs of a clinical facility.

The method includes causing, by a server system, display of at least one user interface (UI) on a display screen of an electronic device associated with a user. The at least one UI is configured to facilitate reservation of blocks and release of previously reserved blocks from among plurality of blocks associated with each Operating Room (OR) from among one or more Operating Rooms (ORs) related to a clinical facility. The plurality of blocks associated with each OR together configure a pool of blocks. Each block from among the pool of blocks is capable of being reserved in advance for performing an OR procedure on a patient. The method includes receiving, by the server system, a request related to at least one block from among the pool of blocks. The request is provisioned by the user for one of reserving the at least one block and releasing a user reservation of the at least one block. The method includes performing, by the server system, at least one action in response to the received request, and updating the UI based on the at least one action. The updated at least one UI is configured to indicate a current available inventory of blocks from among the pool of blocks.

A server system includes a database and a computer system. The database maintains a record of reservation status of a plurality of blocks associated with each Operating Room (OR) from among one or more Operating Rooms (ORs) related to a clinical facility. The plurality of blocks associated with each OR together configure a pool of blocks. Each block from among the pool of blocks is capable of being reserved in advance for performing an OR procedure on a patient. The computer system is in operative communication with the database and includes a processor and at least one memory. At least one memory having stored therein machine executable instructions, that when executed by at least one processor, cause the server system to cause display of at least one user interface (UI) on a display screen of an electronic device associated with a user. At least one UI is configured to facilitate reservation of blocks and release of previously reserved blocks from among the pool of blocks. The server system is further caused to receive a request related to at least one block from among the pool of blocks. The request is provisioned by the user for one of reserving at least one block and releasing a user reservation of at least one block. The server system performs at least one action in response to the received request and updates the UI based on at least one action. The updated at least one UI is configured to indicate a current available inventory of blocks from among the pool of blocks.

An electronic device includes a display screen, an input/output (I/O) module and a communication module. The display screen is configured to display at least one user interface (UI) configured to facilitate reservation of blocks and release of previously reserved blocks from among a plurality of blocks associated with each Operating Room (OR) from among one or more Operating Rooms (ORs) related to a clinical facility. The plurality of blocks associated with each OR together configure a pool of blocks. Each block from among the pool of blocks is capable of being reserved in advance for performing an OR procedure on a patient. The input/module (I/O) module is configured to receive a user request related to at least one block from among the pool of blocks. The request is provisioned by the user for one of reserving at least one block and releasing a user reservation of at least one block. The communication module is configured to communicate the request to a server system. The server system is configured to perform at least one action in response to the received request and update the UI based on the at least one action. The updated at least one UI is configured to indicate a current available inventory of blocks from among the pool of blocks. The display screen is configured to display the updated at least one UI.

A computer program product includes at least one computer-readable storage medium. The computer-readable storage medium includes a set of instructions which, when executed by one or more processors, cause a computing device to cause display of at least one user interface (UI) on a display screen of an electronic device associated with a user. At least one UI is configured to facilitate reservation of blocks and release of previously reserved blocks from among a plurality of blocks associated with each Operating Room (OR) from among one or more Operating Rooms (ORs) related to a clinical facility. The plurality of blocks associated with each OR together configure a pool of blocks. Each block from among the pool of blocks is capable of being reserved in advance for performing an OR procedure on a patient. The computing device is further caused to receive a request related to at least one block from among the pool of blocks. The request is provisioned by the user for one of reserving at least one block and releasing a user reservation of at least one block. The computing device performs at least one action in response to the received request and updates the UI based on at least one action. The updated at least one UI is configured to indicate a current available inventory of blocks from among the pool of blocks.

### BRIEF DESCRIPTION OF THE FIGURES

For a more complete understanding of example embodiments of the present technology, reference is now made to the following descriptions taken in connection with the accompanying drawings in which:

FIG. 1 shows an example representation of an environment for managing reservations of operating room (OR) blocks, in accordance with an example embodiment of the invention.

FIG. 2 shows a simplified representation of a UI displayed to a user for providing a request related to reservation or release of at least one OR block, in accordance with an example embodiment of the invention;

FIG. 3 shows a simplified representation of a UI configured to facilitate reservation of at least one block from available OR blocks, in accordance with an example embodiment of the invention;

FIG. 4 shows a simplified representation of a UI for illustrating a provisioning of a request for reserving an OR block, in accordance with an example embodiment of the invention;

FIG. 5 shows a simplified representation of a UI displayed to a user for communicating a response from a master OR scheduler, in accordance with an example embodiment of the invention;

FIG. 6 shows a simplified representation of a UI for illustrating a provisioning of a request for releasing an OR block, in accordance with an example embodiment of the invention;

FIG. 7 shows a representation of a UI displaying a statistic related to block utilization of an OR associated with a clinical facility, in accordance with an example embodiment of the invention;

FIG. 8 is a flow diagram of a method for managing reservations of OR blocks, in accordance with an example embodiment of the invention;

FIG. 9 shows a block diagram representation of the server system capable of implementing the various embodiments of the present invention; and

FIG. 10 shows a computing device capable of implementing the various embodiments of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Operating rooms are typically reserved in advance for performing medical procedures, such as surgeries, on patients. The various time slots for which an operating room (OR) may be reserved are referred to herein as OR blocks. In conventional mechanisms, the reservation and/or release of OR blocks is performed manually and is inefficient. Generally, it is observed that surgeons having reservations of OR blocks forget to release the blocks in time to let other people have enough time to schedule cases in those ORs. Furthermore, in many example scenarios, the one-time release is sometimes not logged correctly into electronic medical record (EMR) as such communication may happen through multiple channels, such as for example, a surgeon may call his assistant to ask an OR scheduler to release a block, or a surgeon may write an email to the OR scheduler, or the surgeon may even drop by the office and verbally indicate the block release to the OR scheduler.

The various embodiments disclosed herein provide a method and system for managing reservations of OR blocks. More specifically, a server system causes display of at least one UI, which facilitates reservation of blocks and release of previously reserved blocks from among plurality of blocks associated with each OR from among one or more ORs related to a clinical facility. The plurality of blocks associated with each OR together configure a pool of blocks. All stakeholders, such as surgeons, master schedulers, clinic schedulers, medical staff etc., may access the one or more UIs.

In one embodiment, a UI displayed to the user may show real-time availability of OR blocks within the pool of blocks. Having real-time visibility of available blocks, a user such as a surgeon, may request an OR block. In some embodiments, the user may also add comments to add context to the request. For example, the user may mention medical staff (for example, anesthesiologist, etc.) required for a medical procedure, any special equipment required for the surgery, and the like. In some embodiments, an OR block owner may also request to release an OR block using a UI. A master OR scheduler may receive the request to reserve and/or release OR blocks. The master OR scheduler may be authorized to approve, deny or put the request on hold. In an embodiment, the master OR scheduler may evaluate all constraints, such as block availability, room availability, staff availability prior to approving, denying or putting the request on hold. The status of the request may be notified to all the stakeholders, such as the requesting surgeon, the clinic scheduler (in charge of patients), the medical staff, and the like. The UI may be updated based on the status of the request and the updated UI may be configured to indicate a current available inventory of blocks from among the pool of blocks to the user.

In one embodiment, the server system may be configured to facilitate maintenance of a record of all communication related to each OR block in a single thread, thereby ensuring traceability for audit operations. In one embodiment, the system may be configured to send periodic customized reminders and alerts to users. The periodic reminders may remind the users of their OR bookings so that the users can release the OR block in time if not required anymore. The alerts may bring to user's attention of communication, such as recent release of an OR block by another user. A surgeon or a doctor may choose to act upon such communication (for example, by requesting reservation of the released OR block) thereby ensuring better block usage.

As such, the embodiments disclosed herein suggest a method and system that manage reservations of operating blocks in an efficient manner such that surgeons and schedulers can easily release unwanted blocks, and request needed blocks from the true available inventory. Moreover, the system drives higher block utilization by ensuring a high level of accountability for block owners to either fill the blocks efficiently with patient cases, or to release them early if they are not able to.

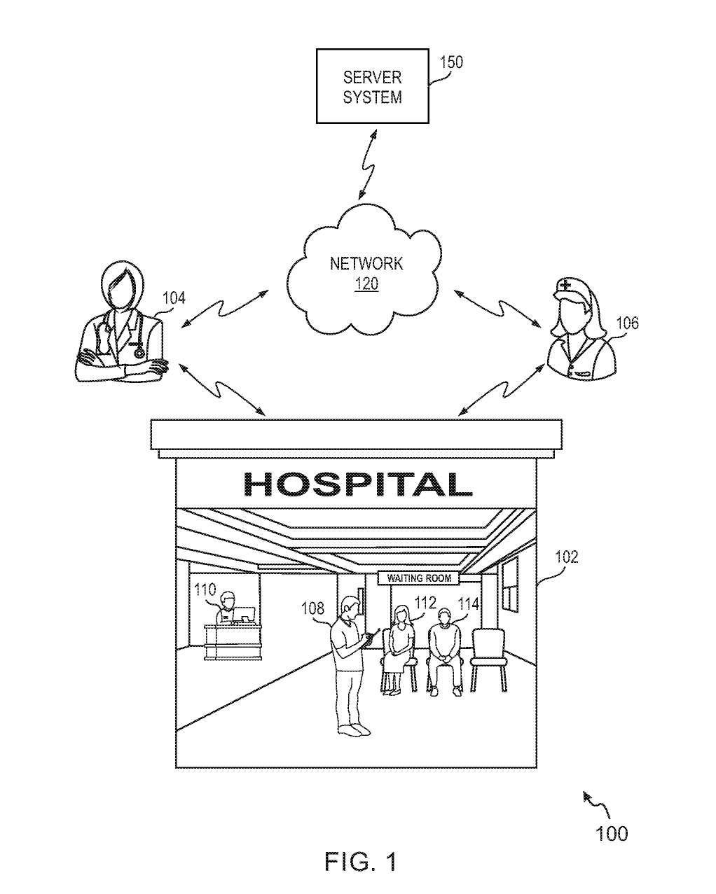

FIG. 1 shows an example representation of an environment 100 for managing reservations of operating room (OR) blocks, in accordance with an example embodiment of the invention.

The environment 100 depicts a simplified representation of a clinical facility 102. Some non-exhaustive examples of the clinical facility 102 may include a hospital, a surgical center, a medical institution, and the like. The clinical facility 102 may include a plurality of operating rooms (ORs) for performing OR procedures, like surgeries. The clinical facility 102 may be associated with doctors/surgeons and medical staff. In FIG. 1, the clinical facility 102 is exemplarily depicted to be associated with a surgeon 104 and a medical staff representative 106.

It is understood that the clinical facility 102 may be associated with several surgeons and a team of medical staff representatives. In an illustrative example, the surgeon 104 may be any of an orthopedic surgeon, an oncologist, a dental surgeon, an ophthalmic surgeon, and the like. In an illustrative example, the medical staff representative 106 may be any of an anesthesiologist, a nurse, an MRI or an X-Ray technician, and the like.

As explained above, the clinical facility 102 may include several ORs. The ORs may need to be reserved in advance for ensuring that the necessary arrangements, like medical staff, equipment, etc., are available for performing the scheduled medical procedure. To that effect, the clinical facility 102 is depicted to be associated with a clinic scheduler 108 and a master OR scheduler. 110. The clinic scheduler 108 may be authorized to interact with the patients, such as patients 112 and 114, and schedule medical procedure cases. The master OR scheduler 110 may be authorized to manage the reservation of various OR booking time slots (referred to herein as OR blocks) as will be explained in further detail later.

The environment 100 further depicts a server system 150 capable of facilitating management of reservations of OR blocks such that surgeons and schedulers can easily release unwanted blocks, and request needed blocks from true available inventory. In at least one example embodiment, the server system 150 may correspond to a Web-based platform (for example, a cloud platform) capable of being accessed over a communication network, such as a network 120. The network 120 may include wired networks, wireless networks and combinations thereof. Some non-limiting examples of the wired networks may include Ethernet, local area networks (LANs), fiber-optic networks, and the like. Some non-limiting examples of the wireless networks may include cellular networks like GSM/3G/4G/5G/LTE/CDMA networks, wireless LANs, Bluetooth, Wi-Fi or Zigbee networks, and the like. An example of the combination of wired and wireless networks may include the Internet.

The Web-based platform may provision OR block management application services as a Web service accessible through a Website. In such a scenario, the various stakeholders, such as the surgeons, master OR schedulers, clinic schedulers, etc., may access the Website over the network 120 using Web browser applications installed in their respective electronic devices and thereafter use the services for managing OR block reservations.

In at least one example embodiment, the server system 150 may also be configured to store an OR block management application program and provision instances of the application to end-users (such as surgeons, medical staff, master OR scheduler, clinic scheduler, etc.) for facilitating management of OR block reservations. The end-users may request the server system 150 to provision access to the application over the network 120. The instances of the application may thereafter be downloaded on the electronic devices of the respective end-users in response to their request for access to the application. Alternatively, in some embodiments, the application may be factory installed within the electronic devices associated with the end-users and, as such, the users may not need to explicitly request the application from the server system 150. In at least one example embodiment, the application may be installed in a kiosk or in one or more booking terminals at the clinical facility 102.

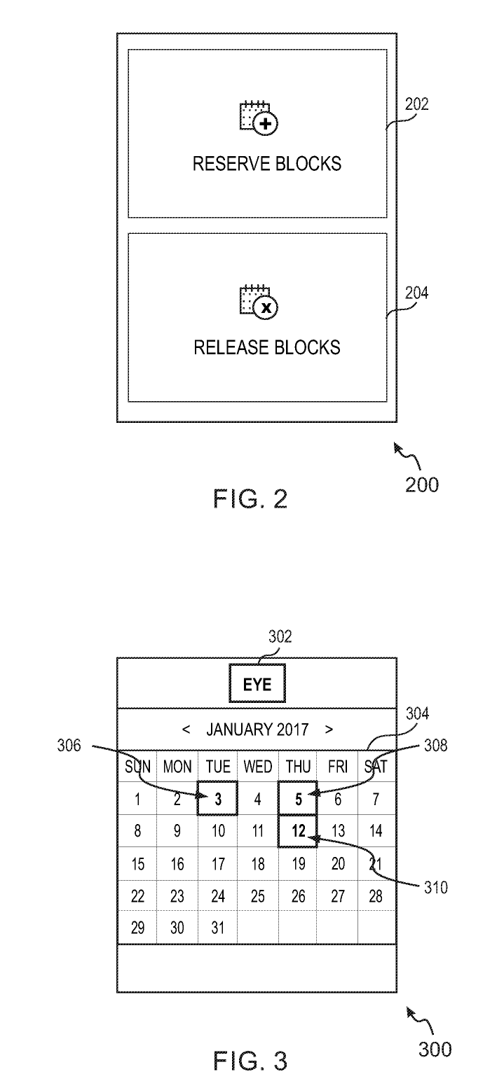

In one embodiment, a user upon accessing the Website and/or the OR block management application associated with the server system 150 may be presented with one or more UIs capable of facilitating reservation of OR blocks and release of previously reserved OR blocks. For the purposes of the description, the plurality of blocks associated with each OR may be considered to configure a pool of blocks, together. It is noted that each block from among the pool of blocks is capable of being reserved in advance for performing an OR procedure on a patient. The various UIs capable of facilitating reservation of OR blocks and release of reserved OR blocks are explained hereinafter with reference to FIGS. 2, 3, 4 and 6.

FIG. 2 shows a simplified representation of a UI 200 displayed to a user for providing a request related to reservation or release of at least one OR block, in accordance with an example embodiment of the invention. The UI 200 may be displayed on a display screen of an electronic device associated with a user. In an illustrative example, the user may correspond to a surgeon, and the electronic device may correspond to a personal computing device of the surgeon. In another illustrative example, the user may correspond to a surgeon and the electronic device may correspond to a workstation (or a kiosk) at the clinical facility. It is noted that the Website and/or the OR block management application may include several UIs in addition to the UI 200.

The UI 200 is exemplarily shown to depict two widgets 202 and 204, showing text “Reserve Blocks” and “Release Blocks”, respectively. The widget 202 may be selected, for example by a click or a touch input, to provision a request for reserving at least one block from among the pool of blocks. The widget 204 may be selected, for example by a click or a touch input, to provision a request for releasing at least one block from among the pool of blocks. It is noted that the UI 200 may include several other icons, such as icons which upon being selected may be configured to display statistics, such as block utilization, a volume of blocks being reserved or released, and the like.

In one embodiment, the server system 150 is configured to cause display of a UI capable of displaying available OR blocks for facilitating reservation of at least one OR block. Such a UI is explained with reference to FIG. 3.

FIG. 3 shows a simplified representation of a UI 300 configured to facilitate reservation of at least one block from available OR blocks, in accordance with an example embodiment of the invention. In an illustrative example, an ophthalmic surgeon may intend to reserve an OR block with a clinical facility for performing an eye surgery on a patient. For purposes of illustration, the clinical facility may be considered to include only one OR having one block capable of being reserved per day. The ophthalmic surgeon may select a tab 302 titled ‘Eye’ to access a calendar view 304 for the month of January. The calendar view 304 depicts three dates 3^{rd} of January, 5^{th} of January and 12^{th} of January (exemplarily depicted using boxes 306, 308 and 310) in a highlighted form, implying only the ORs block on those three days are available for reservation. More specifically, the OR block is currently booked for all remaining days in January.

It is noted that the clinical facility may include several ORs and each OR may be associated with more than one block capable of being reserved per day. In such a scenario, the calendar view 304 may be configured to display only the OR blocks, which are available for booking along with the corresponding dates for which the OR blocks are available for reservation. For example, consider a clinical facility associated with three ORs, such as OR 1, OR 2 and OR 3 with each OR capable of being reserved for three blocks—10 AM to 1 PM, 2 PM to 5 PM and 6 PM to 9 PM. In such a scenario, if a block 10 AM to 1 PM for OR 1 is available on 3^{rd} January, then the calendar view 304 may depict ‘Slot 1, OR 1’ on 3^{rd} January indicating the availability of block for reservation. Similarly, if the block 2 PM to 5 PM for OR 2 and OR 3 is available on 12^{th} January, then the calendar view 304 may depict ‘Slot 2, OR 2’ and ‘Slot 2, OR 3’ on 12^{th} January indicating the availability of blocks for reservation. In some embodiments, if a large number of blocks across ORs are available for reservation on a single day, then the calendar view 304 may be configured to display the availability in a cascaded, scrollable form so as to enable the user to view the plurality of available blocks for several ORs associated with the clinical facility. It is noted that the UI 300 may display several tabs, such as the tab 302 (depicting text ‘Eye’) so as to enable viewing of reservation status of ORs equipped to handle specific type of surgeries. For example, the UI 300 may display tabs, such as ‘ENT’, ‘Dental’, ‘Bone’, and the like. A user selection of such a tab may customize the calendar view 304 to display availability status of blocks of only those ORs capable of handling surgeries related to the selected tab.

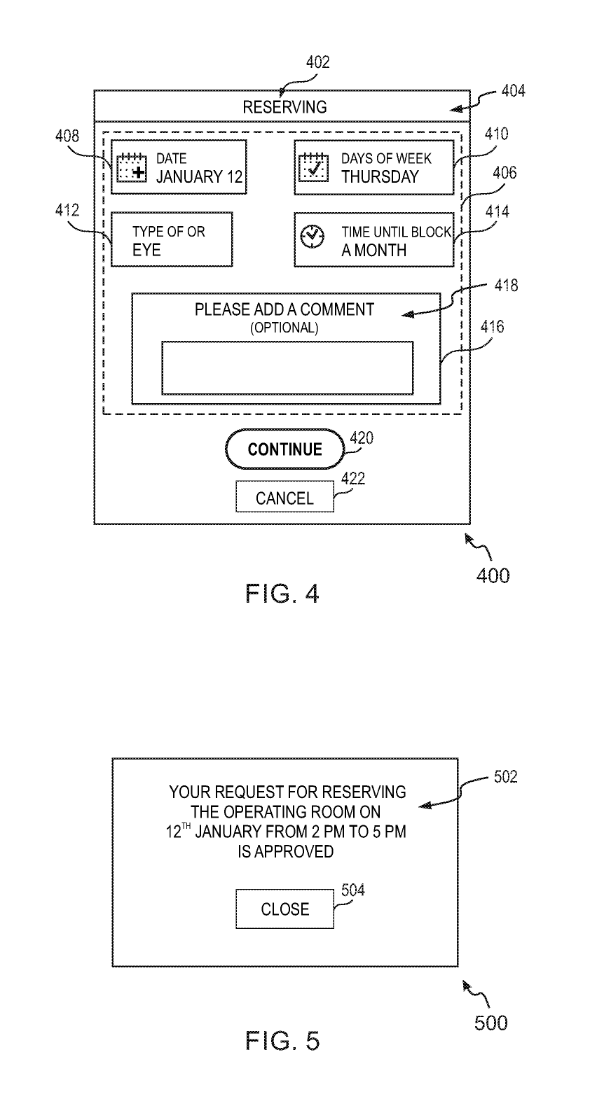

In an embodiment, a user (for example, a surgeon) may provide a selection of an OR block from among the OR blocks available for reservation. The selection of the OR block on the UI 300 may cause display of another UI capable of allowing the user to make a request for reserving the OR block. Such a UI is explained with reference to FIG. 4.

FIG. 4 shows a simplified representation of a UI 400 for illustrating a provisioning of a request for reserving an OR block, in accordance with an example embodiment of the invention. As explained with reference to FIG. 3, a UI showing OR blocks available for reservation may be displayed to a user, and the user may select an OR block from among available OR blocks. The user selection of an OR block on the UI 300 may cause display of a UI, such as the UI 400.

In an example embodiment, the UI 400 is configured to display a message 402 “Reserving” in a header portion 404 to intimate the user that the reservation of the OR block is in progress. The UI 400 may further include a body portion 406 displaying a plurality of information fields with corresponding values. For example, the body portion 406 may display a form field 408 related to a date selected by the user with a corresponding value of ‘January 12’; a form field 410 related to a day of the week with a corresponding value of ‘Thursday’; a form field 412 related to a type of OR with a corresponding value of ‘Eye’, indicating an OR capable of handling an eye related medical procedure; and a form field 414 related to time left for a block with a corresponding value of ‘one month’ to show a time period until which the block is to be kept reserved. Such information may be gleaned from the choices of tab (for example, tab 302) and day/date selected by the user on the UI 300. The value for the time left for block 414 may be selected from a default value. In some embodiments, the UI 400 may be configured to enable the user to make changes to the values displayed in the various form fields.

The UI 400 further depicts a form field 416 with a corresponding message 418 displaying text “Please add a comment (optional)”. In an illustrative example, the user may add a comment to add context to the reservation request. For example, the user (i.e. a surgeon) may mention a patient name or a type of surgery in the form field 416. In some embodiments, the user may add a comment mentioning special equipment required for the surgery in the form field 416. In some embodiments, the user may also mention the number and type of staff (for example, anesthesiologist, nurse, technician, etc.) required for conducting the medical procedure. In case, the user is a master OR scheduler, then the master OR scheduler may add a comment, such as a surgeon name along with staffing/equipment required by the surgeon for conducting the medical procedure.

The UI 400 is further depicted to display buttons 420 and 422 with texts “Continue” and “Cancel”, respectively. In an illustrative example, if the information displayed on the UI 400 is correct and satisfactory to the user, he/she may select the button 420 “Continue”. The selection of the button 422 “Cancel” may direct the user to the UI 300 or UI 200 to start the reservation process again.

In an example embodiment, the values/comments selected in the various form fields of the UI 400 may configure the request for reservation of the OR block. In an embodiment, the selection of the button 410 “Continue” may cause provisioning of the request to the server system 150. It is noted that the communication between the application/Website on the electronic device associated with the user and the server system 150 may be performed in form of application programming interface (API) calls. The API calls may be embodied in form of a data signal capable of being securely transmitted over a communication network, such as the network 120.

In one embodiment, the server system 150 is configured to receive the request for reservation of the OR block and perform at least one action in response to the received request. In one embodiment, the server system 150 may be configured to trigger a notification to one or more stakeholders, such as for example, a master OR scheduler or the OR scheduler (for example, the master OR scheduler 110 or the clinic scheduler 108 as explained with reference to FIG. 1). In an embodiment, the server system 150 may be configured to enable the master OR scheduler to perform one of following three options: (1) approve the request; (2) deny the request, and (3) put the request on hold for a predefined time period. The server system 150 may enable the master OR scheduler to evaluate each request based on constraints like block availability, room availability, staffing and/or equipment availability, and the like. The master OR scheduler may approve or deny the request based on such evaluation of the request. In some embodiments, the master OR scheduler may put the request on hold for a predefined time period if the master OR scheduler requires clarification on one or more constraints associated the request. Once the master OR scheduler receives information on the constraints, the request may then be approved or denied. In at least one example embodiment, the server system 150 may be configured to communicate the response of the master OR scheduler to a plurality of stakeholders. For example, if the master OR scheduler approves the request for reserving a block, then the server system 150 may be caused to communicate the approval to the user, the clinic scheduler, medical staff representatives, and the like.

In some embodiments, the server system 150 may be configured to facilitate creation of a customized policy for reservation and release of blocks for one or more users. For example, in some embodiments, a custom policy to limit certain surgeons to be able to request certain blocks later than peers may be formulated (for example, by the master OR scheduler) and the server system 150 may be configured to support such a custom policy as a part of advanced configuration. In another illustrative example, the advanced configuration may limit surgeons to release OR blocks according to certain policy on when to release and how much to release. For example, when an orthopedic surgeon releases an OR block, the OR block may be available for other orthopedic surgeons only to see and request for some days and then become available to other surgeons (cardiac, general, ENT etc.). Accordingly, the server system 150 may be configured to facilitate creation of custom policy defining which OR block being released may be made available to which surgeon(s) for how long and when the OR blocks may be added to the public pool.

FIG. 5 shows a simplified representation of a UI 500 displayed to a user for communicating a response from the master OR scheduler, in accordance with an example embodiment of the invention. More specifically, the UI 500 depicts a message 502 including text “Your request for reserving the operating room on 12^{th} January from 2 PM to 5 PM is approved”. As explained with reference to FIG. 4, the server system 150 may be configured to notify a master OR scheduler of a request from a user for reserving one or more OR blocks. The master OR scheduler may evaluate the request by performing various constraint checks and approve or deny the request if the constraints are satisfactorily met or not. If the constraints are met, then the master OR scheduler may approve the request and the approval may be communicated to the user by causing a display of an UI, such as the UI 500, on a display screen of the electronic device associated with the user. It is noted that if the master OR scheduler denies the request for reservation of the one or more blocks or puts the request on hold, then an appropriate message such as for example, “Reservation request denied” or “Reservation request is pending approval” may be displayed to the user on the UI 500. In some embodiments, if the user in his/her comments had requested for special equipment or presence of a particular staff member (for example, an anesthesiologist) and if such equipment or staff is not available for the desired OR block, then the message denying the request for reserving the block may include a reason (such as unavailability of the equipment and/or staff) for denial of the user request. In some scenarios, the master OR scheduler may put the request on hold till the staff/equipment availability is clear and thereafter approve or deny the request once the status of all constraints is clear to the master OR scheduler. In such scenarios, the user may log on to the Website or visit the application after a number of days to check whether the pending request has been approved. Alternatively, the user may be notified by an email or a text message about such change in status from hold to approved or denied status.

The UI 500 further depicts a button 504 displaying text “Close”. The user may select the button 504 to close the UI 500. In some embodiments, when the user's request for reserving the one or more OR blocks is denied, the selection of the button 504 may direct the user to another UI, such as the UI 200 or UI 300, explained with reference to FIGS. 2 and 3, to facilitate reservation of another OR block from among the pool of OR blocks. In some embodiments, when the user's request for reserving the one or more OR blocks is approved, the selection of the button 504 may direct the user to another UI showing details of the reservation, such as for example, date of reservation, day of the week corresponding to the reservation, type of OR, etc.

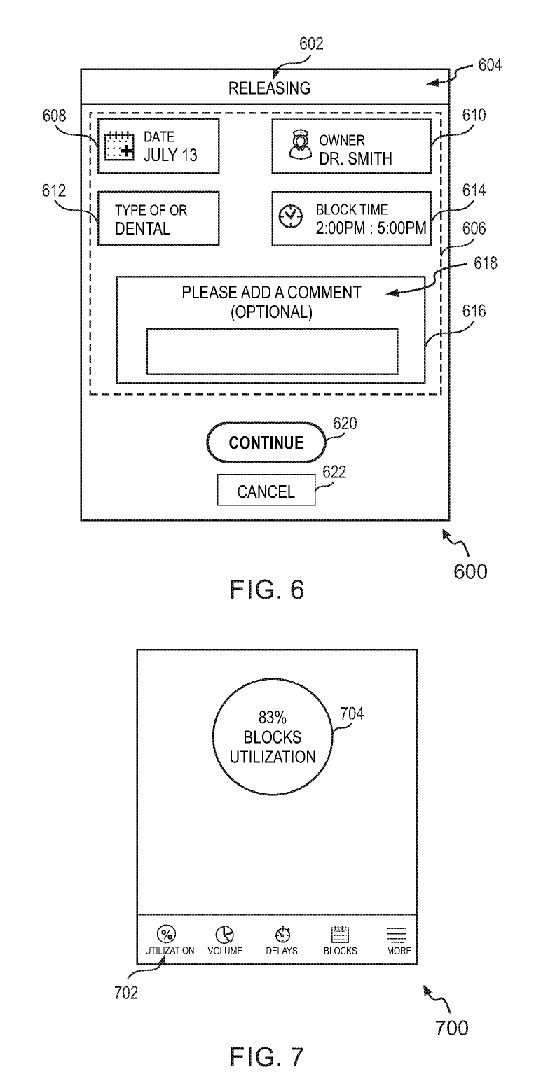

As explained with reference to FIG. 2, a user such as a surgeon for instance may access the Website or the application to request reservation of OR blocks or release currently reserved OR blocks. The reservation of the OR blocks has been explained with reference to FIGS. 3 to 5. The releasing of the user reservation of OR blocks may be initiated by user selection of the widget 204 on the UI 200 (shown in FIG. 2). A UI displayed to the user subsequent to user selection of the widget 204 on the UI 200 is explained next with reference to FIG. 6.

FIG. 6 shows a simplified representation of a UI 600 for illustrating a provisioning of a request for releasing an OR block, in accordance with an example embodiment of the invention. As explained with reference to FIG. 2, a UI such as the UI 200 may be displayed to the user subsequent to accessing the Website or the OR block management application provisioned by the server system 150. The user may select a widget to indicate his/her intention. For example, the user may select the widget 204 to indicate an intention to release the user reservation of one or more OR blocks. Subsequent to selection of such a widget, a UI such as the UI 300 may be displayed to the user. The UI 300 may be show a calendar view with one or more dates highlighted corresponding to the dates on which OR blocks are reserved by the user. A user may provide a selection input on a date in the calendar view to cause display of an UI, such as the UI 600 shown in FIG. 6.

The UI 600 is configured to display a message 602 “Releasing” in a header portion 604 to intimate the user that the releasing of the previously reserved OR block is in progress. The UI 600 further includes a body portion 606 displaying a plurality of form fields with corresponding values. For example, the body portion 606 displays a form field 608 related to a date selected by the user with a corresponding value of ‘July 13’; a form field 610 related to an owner of the OR block with a corresponding value of ‘Dr. Smith’; a form field 612 related to a type of OR with a corresponding value of ‘Dental’, indicating an OR capable of handling a dental medical procedure; and a form field 614 related to OR block with a corresponding value of “2 PM-5 PM”. More specifically, the form fields confirms that the user ‘Dr. Smith’ intends to release an OR block from ‘2 PM to 5 PM’ on July 13.

The UI 600 further depicts a form field 616 with a corresponding message 618 displaying text “Please add a comment (optional)”. In an illustrative example, the user may add a comment related to a reason for releasing the OR block, thereby adding context to the release request. In an illustrative example, the user (for example, a surgeon) may be traveling to a conference and may not be able to conduct the medical procedure on the previously reserved date/day. In one embodiment, the user (for example, a surgeon) may request that the OR block be reserved in name of a colleague instead. For example, Dr. Smith may request that the OR block be released from his name and instead be reserved in name of Dr. Cynthia.

The UI 600 is further depicted to display buttons 620 and 622 with texts “Continue” and “Cancel”, respectively. In an illustrative example, if the information displayed on the UI 600 is correct and satisfactory to the user, he/she may select the button 620 “Continue”. The selection of the button 622 “Cancel” may direct the user to the UI 200 or UI 300 to start the reservation procedure again.

In an example embodiment, the values/comments selected in the various form fields of the UI 600 may configure the request for releasing the user reservation of the OR block. In an embodiment, the selection of the button 620 “Continue” may cause provisioning of the request to the server system 150. It is noted that the communication between the application/Website on the electronic device associated with the user and the server system 150 may be performed in form of application programming interface (API) calls. The API calls may be embodied in form of a data signal capable of being securely transmitted over a communication network, such as the network 120.

In one embodiment, the server system 150 is configured to receive the request for release of the OR block and perform at least one action in response to the received request. In one embodiment, the server system 150 may be configured to trigger a notification to one or more stakeholders, such as for example, a master OR scheduler or the clinic scheduler (for example, the master OR scheduler 110 or the clinic scheduler 108 explained with reference to FIG. 1). In an embodiment, the server system 150 may be configured to enable the master OR scheduler to approve/deny or hold the request for releasing the user reservation of the OR block. In one embodiment, the server system 150 may be configured to communicate the response of the master OR scheduler to one or more stakeholders, such as for example, the user requesting release of the OR block, the surgeon to whom the OR block may be transferred, the clinic scheduler, the medical staff reserved for the OR procedure, and the like. In one embodiment, the server system 150 may be configured to facilitate maintenance of a record of all communication related to each OR block in a single thread, thereby ensuring traceability for audit operations.

In one embodiment, the server system 150 may be configured to send periodic reminders and alerts to users. The periodic reminders may be sent to remind the users of their OR bookings so that the user can release the OR block in time if not required anymore. The alerts may bring to user's attention of communication, such as recent release of an OR block by another user. A surgeon or a doctor may choose to act upon such communication (for example, by requesting reservation of the released OR block) thereby ensuring better block usage.

In at least some embodiments, the server system 150 may utilize predictive analysis and machine learning techniques on EHR (Electronic Health Records), clinic and other existing data to significantly improve OR performance. Further, the server system 150 may be configured to monitor booking patterns of each OR to identify blocks that are likely to be underutilized and remind surgeons and OR schedulers to proactively release them if not needed.

The server system 150 may also be configured to predict OR utilization of an OR for time of a day and a day of a week and use optimization algorithms to recommend staffing plans to minimize the risk of over and under staffing and in turn improve the OR performance. Further, the server system 150 may be configured to send timely mobile alerts to the surgeons about how they are contributing to OR volumes, how their performance metrics are trending and ways to improve their utilization.

In one embodiment, the server system 150 may also be configured to compute statistical information, such as for example, block usage patterns, volume and type of surgeries conducted per month, monthly variance in OR usage, and the like. The server system 150 may further be configured to cause display of such statistical information on the display screen of the electronic device. An example statistical information displayed to the user is depicted in FIG. 7.

FIG. 7 shows a representation of a UI 700 displaying a statistic related to block utilization of an OR associated with a clinical facility, in accordance with an example embodiment of the invention. The UI 700 depicts a menu section with several options, such as an option 702 displaying text ‘Utilization %’. A user may provide a touch or click input on the option 702 to obtain a visual representation 704 showing 83% block utilization for an OR block. The UI 700 may be configured to display various kinds of statistical information, such as number of unique surgeons using the OR, volume of each type of medical procedure, and the like. The display of such statistical information may not be limited to the format depicted using the visual representation 704. Indeed various types of statistical information may be displayed in several ways. The master OR scheduler and/or the clinic scheduler may view such display of statistical information and take action to drive better block utilization. In one embodiment, the utilization information may also facilitate audit operations.

In at least one example embodiment, the server system 150 is configured to update the UI based on the at least one action. For example, based on the approval or denial of the user request for reserving or releasing the OR blocks by the master OR scheduler, the server system 150 may be configured to update the OR block availability, such that the UIs indicate a current available inventory of blocks from among the pool of blocks to the users. In at least one example embodiment, a track of the request, release, approved request or release, denied request or release etc., may be maintained leading to better traceability for audit operations.

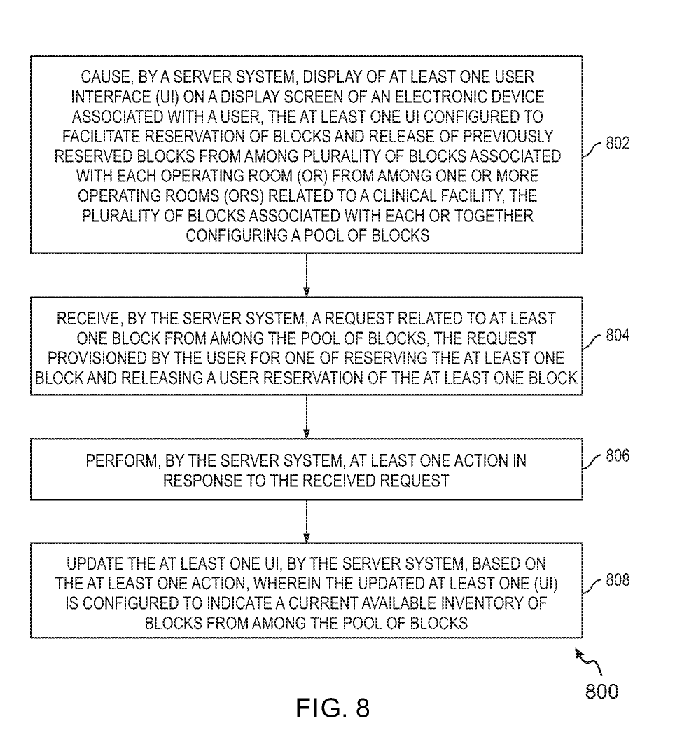

FIG. 8 is a flow diagram of a method 800 for managing reservations of OR blocks, in accordance with an example embodiment of the invention. The various steps and/or operations of the flow diagram, and combinations of steps/operations in the flow diagram, may be implemented by, for example, hardware, firmware, a processor, circuitry and/or by the server system 150 of FIG. 1 and/or by a different electronic device associated with the execution of software that includes one or more computer program instructions. The method 800 starts at operation 802.

At 802, display of at least one user interface (UI) on a display screen of an electronic device associated with a user is caused by a server system, such as the server system 150 explained with reference to FIGS. 1 to 7. The at least one UI is configured to facilitate reservation of blocks and release of previously reserved blocks from among plurality of blocks associated with each OR from among ORs related to a clinical facility. The plurality of blocks associated with each OR together configure a pool of blocks, where each block from among the pool of blocks is capable of being reserved in advance for performing an OR procedure on a patient. Some example UIs facilitating reservation of blocks and release of previously reserved blocks are explained with reference to FIGS. 2, 3, 4 and 6.

At 804, a request related to at least one block from among the pool of blocks is received. The request is provisioned by the user for one of reserving the at least one block or releasing a user reservation of the at least one block. As explained with reference to FIG. 2, the UI 200 may be provisioned to the user on his/her electronic device showing widgets 202 and 204, respectively, for making a corresponding request for reserving or releasing the blocks of the OR. Based on the user input, the next UIs may be provisioned to the user accordingly.

At 806, at least one action is performed by the server system in response to the received request. In one embodiment, the action may correspond to notifying one or more stakeholders, such as a master OR scheduler, a surgeon, a clinic scheduler, a medical staff representative. In one embodiment, the master scheduler may evaluate the request based on constraints such as block availability, room availability, staff/equipment availability and either approve the request, deny the request or put the request on hold. The server system may be configured to notify the user of the response of the master OR scheduler.

At 808, the at least one UI is updated by the server system based on the at least one action. The updated at least one UI is configured to indicate a current available inventory of blocks from among the pool of blocks. More specifically, the UI showing the latest status of reservations of various blocks associated with several ORs is reflected in the updated at least one UI. The method 800 ends at step 808.

The disclosed method 800 or one or more operations of the method 800 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

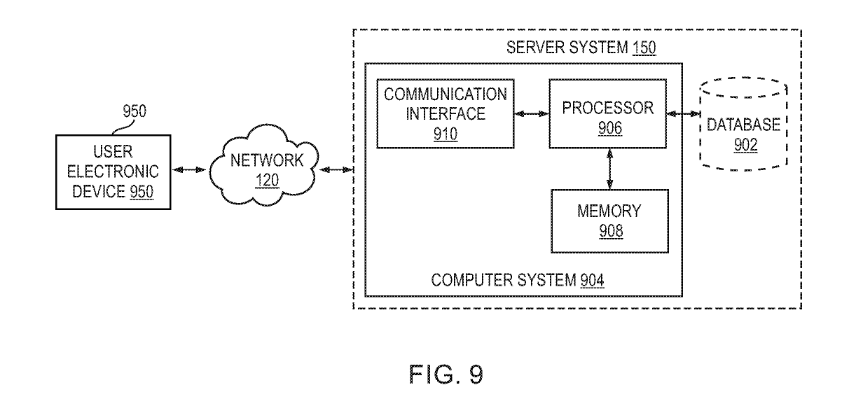

FIG. 9 shows a block diagram representation of the server system 150 capable of implementing the various embodiments of the present invention. The system 150 includes a database 902 and a computer system 904. The computer system 904 includes at least one processor 906, a memory 908 and a communication interface 910 for facilitating management of OR block reservations. In at least one embodiment, the server system 150 may be accessible to user electronic devices, such as a user electronic device 950, through a communication network, such as the network 120.

The database 902 is any computer-operated hardware suitable for storing and/or retrieving data, such as, but not limited to, a current availability status of a plurality of blocks associated with the ORs associated with the clinical facility. The database 902 may also maintain contact details, such as email IDs and phone numbers of all medical staff representatives, master OR schedulers, surgeons, patients and clinic schedulers. The database 902 may also maintain a list of constraints to be checked while facilitating approval/denial or putting user requests on hold.

The database 902 may include multiple storage units such as hard disks and/or solid-state disks in a redundant array of inexpensive disks (RAID) configuration. The database 902 may include a storage area network (SAN) and/or a network attached storage (NAS) system.

In some embodiments, the database 902 is integrated within computer system 904. For example, computer system 904 may include one or more hard disk drives as database 902. In other embodiments, database 902 is external to computer system 904 and may be accessed by the computer system 904 using a storage interface. The storage interface is any component capable of providing processor 906 with access to the database 902. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 906 with access to the database 902.

The processor 906 is capable of executing the stored machine executable instructions in the memory 908 or within the processor 906 or any storage location accessible to the processor 906. The processor 906 is configured to perform the various operations as explained with reference to method 800. For example, the processor 906 is configured to cause display of one or more UIs facilitating reservation and release of blocks from among a plurality of blocks associated with each Operating Room (OR) from among one or more Operating Rooms (ORs) related to a clinical facility. The one or more UIs may be displayed on a display screen of the electronic device 950. The processor 906 is further configured to receive a request provisioned by the user for one of reserving the at least one block or releasing a user reservation of the at least one block and perform at least one action in response to the received request. The processor 906 is also configured to update the one or more UIs based on the at least one action. The updated one or more UIs are configured to indicate a current available inventory of blocks from among the plurality of blocks associated with each OR.

In an embodiment, the processor 906 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The memory 908 may be configured to store the platform instructions for the processor 906 to execute for facilitating management of OR block reservations. The memory 908 is a storage device embodied as one or more volatile memory devices, one or more non-volatile memory devices, and/or a combination of one or more volatile memory devices and non-volatile memory devices, for storing micro-contents information and instructions. The memory 908 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.).

The communication interface 910 is configured to facilitate communication between the server system 150 and electronic devices associated with users, such as surgeons, master OR scheduler, clinic scheduler, and the like. The communication interface 910 is configured to cause display of UIs on the electronic devices, such as the UIs 200, 300, 400, 500 and 600, thereby enabling the users to reserve OR blocks and release unwanted OR blocks. The communication module 904 may further be configured to send notifications to the master OR scheduler as well as alerts and reminders to the plurality of stakeholders. The communication may be achieved over a communication network, such as the network 120. As explained above, the communication related to each OR block is maintained in a single thread in the database 902, thereby ensuring traceability for audit operations.

In at least some example embodiments, the server system 150 may include an I/O module (not shown in FIG. 9) configured to receive inputs from and provide outputs to the user of the server system 150. To that effect, the I/O module may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a microphone, a speaker, a ringer, a vibrator, and the like.

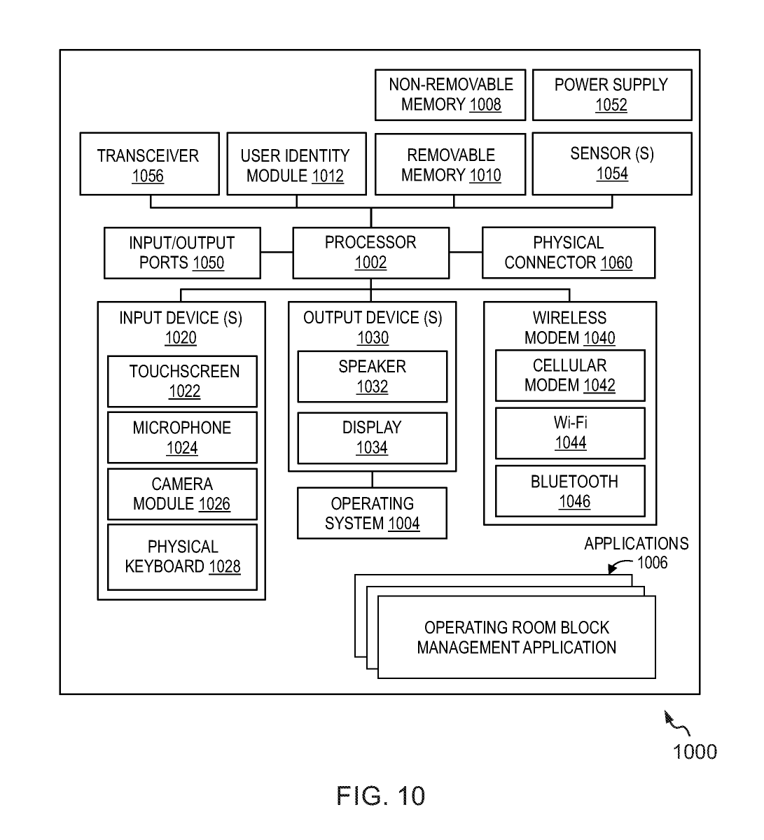

FIG. 10 shows an electronic device 1000 capable of implementing the various embodiments of the present invention. In an embodiment, the various operations performed by the server system 150 may be implemented using an application in an electronic device, such as the electronic device 1000. For example, the electronic device 1000 may correspond to an electronic device associated with a user, such as for example, a surgeon, a master OR scheduler, a clinic scheduler, a medical staff representative, and the like. The electronic device 1000 is depicted to include one or more applications 1006, including an OR block management application, which serves as an instance of the application downloaded from the server system 150 and capable of communicating through API calls with the server system 150 to facilitate management of reservation of OR blocks.

It should be understood that the electronic device 1000 as illustrated and hereinafter described is merely illustrative of one type of device and should not be taken to limit the scope of the embodiments. As such, it should be appreciated that at least some of the components described below in connection with that the electronic device 1000 may be optional and thus in an example embodiment may include more, less or different components than those described in connection with the example embodiment of the FIG. 10. As such, among other examples, that the electronic device 1000 could be any of a mobile electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1000 includes a controller or a processor 1002 (e.g., a signal processor, microprocessor, ASIC, or other control and processing logic circuitry) for performing such tasks as signal coding, data processing, image processing, input/output processing, power control, and/or other functions. An operating system 1004 controls the allocation and usage of the components of the electronic device 1000 and support for one or more applications programs (see, applications 1006), such as OR block management application, that implements one or more of the innovative features described herein. In addition to OR block management application, the applications 1006 may include common mobile computing applications (e.g., telephony applications, email applications, calendars, contact managers, web browsers, messaging applications) or any other computing application. The OR block management application, in at least one example embodiment, may be configured to provide the logic to manage OR block reservations for various ORs of a clinical facility, as explained with reference to FIGS. 1 to 9.

The illustrated electronic device 1000 includes one or more memory components, for example, a non-removable memory 1008 and/or removable memory 1010. The non-removable memory 1008 and/or removable memory 1010 may be collectively known as database in an embodiment. The non-removable memory 1008 can include RAM, ROM, flash memory, a hard disk, or other well-known memory storage technologies. The removable memory 1010 can include flash memory, smart cards, or a Subscriber Identity Module (SIM). The one or more memory components can be used for storing data and/or code for running the operating system 1004 and the applications 1006.

The electronic device 1000 can support one or more input devices 1020 and one or more output devices 1030. The input devices 1020 and the output devices 1030 configure the input/output (I/O) module for the electronic device 1000. Examples of the input devices 1020 may include, but are not limited to, a touch screen/a display screen 1022 (e.g., capable of capturing finger tap inputs, finger gesture inputs, multi-finger tap inputs, multi-finger gesture inputs, or keystroke inputs from a virtual keyboard or keypad), a microphone 1024 (e.g., capable of capturing voice input), a camera module 1026 (e.g., capable of capturing still picture images and/or video images) and a physical keyboard 1028. Examples of the output devices 1030 may include, but are not limited to a speaker 1032 and a display 1034. Other possible output devices can include piezoelectric or other haptic output devices. Some devices can serve more than one input/output function. For example, the touch screen 1022 and the display 1034 can be combined into a single input/output device.

A wireless modem 1040 can be coupled to one or more antennas (not shown in the FIG. 10) and can support two-way communications between the processor 1002 and external devices, as is well understood in the art. The wireless modem 1040 is shown generically and can include, for example, a cellular modem 1042 for communicating at long range with the mobile communication network, a Wi-Fi compatible modem 1044 for communicating at short range with an external Bluetooth-equipped device or a local wireless data network or router, and/or a Bluetooth-compatible modem 1046. The wireless modem 1040 is typically configured for communication with one or more cellular networks, such as a GSM network for data and voice communications within a single cellular network, between cellular networks, or between the electronic device 1000 and a public switched telephone network (PSTN). The wireless modem 1040 may in at least one example embodiment configure the communication module of the electronic device 1000.

The electronic device 1000 can further include one or more input/output ports 1050, a power supply 1052, one or more sensors 1054 for example, an accelerometer, a gyroscope, a compass, or an infrared proximity sensor for detecting the orientation or motion of the electronic device 1000, a transceiver 1056 (for wirelessly transmitting analog or digital signals) and/or a physical connector 1060, which can be a USB port, IEEE 1294 (FireWire) port, and/or RS-232 port. The illustrated components are not required or all-inclusive, as any of the components shown can be deleted and other components can be added.

Various example embodiments offer, among other benefits, techniques for efficient management of OR block reservations. The methods and systems disclosed herein provide a seamless marketplace for surgeons and schedulers to easily release unwanted blocks, and request needed blocks from the true available inventory. The releasing of blocks as suggested herein ensures a high level of accountability for block owners to either fill them efficiently with patient cases, or to release them early if they are not able to. Moreover, the block inventory opens up opportunities for new surgeons and surgeons with high demand to have access to blocks they need.

The various embodiments as disclosed herein also provide an audit trail through email and all block decisions such as request, release, approved request or release, denied request or release etc., are tracked in a single thread, which leads to better traceability. The audit trail better connects all the stakeholders in the block transactions and allows for faster, more focused communication.

The invention allows advanced configuration by limiting certain surgeons to release according to certain policy on when to release and how much to release. In some embodiments, the invention allows advanced configuration by limiting certain surgeons to be able to request certain blocks later than peers. The invention also suggest techniques for putting reservation of blocks on hold if there are specific equipment or other constraints on approving them immediately, and allows OR administration to defer decisions until a time when this is clear.

The server system sends out programmable reminders so no blocks are forgotten to be released. Moreover, various techniques disclosed herein allow schedulers and surgeons to track the communication easily and in one place. The invention makes the communication efficient by creating a marketplace and making the inventory of block time transparent.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the server system 150 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIG. 8). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
causing, by a server system, display of at least one user interface (UI) on a display screen of an electronic device associated with a user, the at least one UI configured to facilitate reservation of blocks and release of previously reserved blocks from among plurality of blocks associated with each Operating Room (OR) from among one or more Operating Rooms (ORs) related to a clinical facility, the plurality of blocks associated with each OR together configuring a pool of blocks, each block from among the pool of blocks capable of being reserved in advance for performing an OR procedure on a patient;
receiving, by the server system, a request related to at least one block from among the pool of blocks, the request provisioned by the user for one of reserving the at least one block and releasing a user reservation of the at least one block;
performing, by the server system, at least one action in response to the received request; and
updating the at least one UI, by the server system, based on the at least one action, wherein the updated at least one UI is configured to indicate a current available inventory of blocks from among the pool of blocks.

2. The method as claimed in claim 1, further comprising:
for the request corresponding to reservation of the at least one block, facilitating the user to provide, by the server system, at least one of:
one or more comments for adding context to the reservation request;
staffing requirement for performing the OR procedure; and
equipment requirement for performing the OR procedure.

3. The method as claimed in claim 1, further comprising:
for the request corresponding to the releasing of the user reservation of the at least one block, facilitating the user to provide, by the server system, one or more comments for adding context to the reservation release request.

4. The method as claimed in claim 1, wherein an action from among the at least one action corresponds to triggering a notification to a plurality of stakeholders, the plurality of stakeholders comprising at least one of a master OR scheduler, a surgeon, a clinic scheduler and a medical staff representative.

5. The method as claimed in claim 4, further comprising:
facilitating, the master OR scheduler to perform one of:
approve the request related to the at least one block;
deny the request related to the at least one block; and
put the request related to the at least one block on hold for a predefined time period.

6. The method as claimed in claim 5, wherein the request related to the at least one block is put on hold for a predefined time period if the master OR scheduler requires clarification on one or more constraints associated with the request related to the at least one block, wherein the one or more constraints comprise constraints related to at least one of staffing availability, equipment availability and room availability for performing the OR procedure.

7. The method as claimed in claim 1, wherein the request for releasing the user reservation of the at least one block comprises request for reserving the at least one block for another user associated with the user.

8. The method as claimed in claim 1, further comprising:
facilitating, by the server system, maintenance of record of all communication for each request related to each block from among the pool of blocks, the maintenance of the record of communication configuring a traceable audit trail.

9. The method as claimed in claim 1, further comprising:
periodically sending, by the server system, customized reminders and alerts to a plurality of stakeholders associated with reservation of the pool of blocks.

10. The method as claimed in claim 1, further comprising:
facilitating, by the server system, creation of a customized policy for reservation and release of blocks for one or more users.

11. A server system comprising:
a database maintaining a record of reservation status of a plurality of blocks associated with each Operating Room (OR) from among one or more Operating Rooms (ORs) related to a clinical facility, the plurality of blocks associated with each OR together configuring a pool of blocks, each block from among the pool of blocks capable of being reserved in advance for performing an OR procedure on a patient; and
a computer system in operative communication with the database, the computer system comprising a processor and at least one memory, the at least one memory having stored therein machine executable instructions, that when executed by the at least one processor, cause the server system to:
cause display of at least one user interface (UI) on a display screen of an electronic device associated with a user, the at least one UI configured to facilitate reservation of blocks and release of previously reserved blocks from among the pool of blocks;
receive a request related to at least one block from among the pool of blocks, the request provisioned by a user for one of reserving the at least one block and releasing a user reservation of the at least one block;
perform at least one action in response to the received request; and
update the at least one UI based on the at least one action, wherein the updated at least one UI is configured to indicate a current available inventory of blocks from among the pool of blocks.

12. The server system as claimed in claim 11, wherein the server system is further caused to:
for the request corresponding to reservation of the at least one block, facilitating the user to provide at least one of:
one or more comments for adding context to the reservation request;
staffing requirement for performing the OR procedure; and
equipment requirement for performing the OR procedure.

13. The server system as claimed in claim 11, wherein the server system is further caused to:
for the request corresponding to the releasing of the user reservation of the at least one block, facilitating the user to provide one or more comments for adding context to the reservation release request.

14. The server system as claimed in claim 11, wherein an action from among the at least one action corresponds to triggering a notification to a plurality of stakeholders, the plurality of stakeholders comprising at least one of a master OR scheduler, a surgeon, a clinic scheduler and a medical staff representative.

15. The server system as claimed in claim 14, wherein the server system is further caused to:
facilitate the master OR scheduler to perform one of:
approve the request related to the at least one block;
deny the request related to the at least one block; and
put the request related to the at least one block on hold for a predefined time period, wherein the request related to the at least one block is put on hold for a predefined time period if the master OR scheduler requires clarification on one or more constraints associated with the request related to the at least one block, wherein the one or more constraints comprise constraints related to at least one of staffing availability, equipment availability and room availability for performing the OR procedure.

16. An electronic device comprising:
a display screen configured to display at least one user interface (UI) configured to facilitate reservation of blocks and release of previously reserved blocks from among a plurality of blocks associated with each Operating Room (OR) from among one or more Operating Rooms (ORs) related to a clinical facility, the plurality of blocks associated with each OR together configuring a pool of blocks, each block from among the pool of blocks capable of being reserved in advance for performing an OR procedure on a patient;
an input/module (I/O) module configured to receive a user request related to at least one block from among the pool of blocks, the request provisioned by the user for one of reserving the at least one block and releasing a user reservation of the at least one block; and
a communication module configured to communicate the request to a server system, the server system configured to perform at least one action in response to the received request and update the at least one UI based on the at least one action, the updated at least one UI configured to indicate a current available inventory of blocks from among the pool of blocks,
wherein the display screen is configured to display the updated UI.

17. A computer program product comprising at least one computer-readable storage medium, the computer-readable storage medium comprising a set of instructions which, when executed by one or more processors, cause a computing device to:
cause display of at least one user interface (UI) on a display screen of an electronic device associated with a user, the at least one UI configured to facilitate reservation of blocks and release of previously reserved blocks from among a plurality of blocks associated with each Operating Room (OR) from among one or more Operating Rooms (ORs) related to a clinical facility, the plurality of blocks associated with each OR together configuring a pool of blocks, each block from among the pool of blocks capable of being reserved in advance for performing an OR procedure on a patient;
receive a request related to at least one block from among the pool of blocks, the request provisioned by the user for one of reserving the at least one block and releasing a user reservation of the at least one block;
perform at least one action in response to the received request; and
update the at least one UI based on the at least one action, wherein the updated at least one UI is configured to indicate a current available inventory of blocks from among the pool of blocks.

18. The computer program product as claimed in claim 17, wherein the computing device is further caused to:
for the request corresponding to reservation of the at least one block, facilitating the user to provide at least one of:
one or more comments for adding context to the reservation request;
staffing requirement for performing the OR procedure; and
equipment requirement for performing the OR procedure.

19. The computer program product as claimed in claim 17, wherein an action from among the at least one action corresponds to triggering a notification to a plurality of stakeholders, the plurality of stakeholders comprising at least one of a master OR scheduler, a surgeon, a clinic scheduler and a medical staff representative.

20. The computer program product as claimed in claim 19, wherein the computing device is further caused to:
facilitate the master OR scheduler to perform one of:
approve the request related to the at least one block;
deny the request related to the at least one block; and
put the request related to the at least one block on hold for a predefined time period, wherein the request related to the at least one block is put on hold for a predefined time period if the master OR scheduler requires clarification on one or more constraints associated with the request related to the at least one block, wherein the one or more constraints comprise constraints related to at least one of staffing availability, equipment availability and room availability for performing the OR procedure.
